(19) United States
(12) Patent Application Publication
(10) Pub. No.: US 2010/0061287 A1
(43) Pub. Date: Mar. 11, 2010

(54) Efficient coding schemes for retransmissions in multicast transmission

(75) Inventors: Kaushik Josiam, Dallas, TX (US); Farooq Khan, Allen, TX (US); Zhouyue Pi, Richardson, TX (US)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/387,296

(22) Filed: Apr. 30, 2009

Related U.S. Application Data
(60) Provisional application No. 61/191,611, filed on Sep. 10, 2008.

(51) Int. Cl. H04H 20/71

(52) U.S. Cl. 370/312

(57) ABSTRACT

For use in a multicast wireless communication network comprising a plurality of base stations, various methods for encoding retransmissions to a plurality of mobile stations are provided. Each method includes transmitting a plurality of data packets to the plurality of mobile stations. Each method also includes creating at least one redundancy packet by using at least two of the plurality of data packets and binary XOR addition. Each method further includes transmitting at least one redundancy packet to the plurality of mobile stations.

### CROSS-REFERENCE TO RELATED APPLICATION(S) AND CLAIM OF PRIORITY

The present application is related to U.S. Provisional Patent No. 61/191,611, filed Sep. 10, 2008, entitled “EFFICIENT CODING SCHEMES FOR RETRANSMISSIONS IN MULTICAST TRANSMISSION”. Provisional Patent No. 61/191,611 is assigned to the assignee of the present application and is hereby incorporated by reference into the present application as if fully set forth herein. The present application hereby claims priority under 35 U.S.C. §119(e) to U.S. Provisional Patent No. 61/191,611.

### TECHNICAL FIELD OF THE INVENTION

The present application relates generally to wireless communications systems and, more specifically, to methods of efficiently coding retransmissions in a multicast transmission environment.

### BACKGROUND OF THE INVENTION

Multicast transmission in wireless networks occurs when one source transmits the same data to multiple destinations. In the context of cellular networks, multicast transmission occurs from a base station (BS) to multiple mobile stations (MS) on the downlink. Examples of multicast transmission include mobile TV, disaster warning systems, etc.

Automatic Repeat Query (ARQ) is an error control method for data transmission which uses acknowledgments and timeouts to achieve reliable data transmission. Hybrid ARQ is a retransmission scheme whereby the transmitter sends redundant coded information in multiple subpackets. The subpackets are generated at the transmitter by first performing channel coding on the information packet and then breaking the resulting coded bit stream into smaller subpackets as shown in FIG. 1.

### SUMMARY OF THE INVENTION

For use in a multicast wireless communication network comprising a plurality of base stations, a method for encoding retransmissions to a plurality of mobile stations is provided. The method includes transmitting a plurality of data packets to the plurality of mobile stations. The method also includes creating at least one redundancy packet by using at least two of the plurality of data packets and binary XOR addition. The method further includes transmitting the at least one redundancy packet to the plurality of mobile stations.

A multicast wireless communication network comprising a plurality of base stations is provided. Each of the base stations is capable of encoding retransmissions to a plurality of mobile stations. Each base station is configured to transmit a plurality of data packets to the plurality of mobile stations. Each base station is also configured to create at least one redundancy packet by using at least two of the plurality of data packets and binary XOR addition. Each base station is further configured to transmit the at least one redundancy packet to the plurality of mobile stations.

A mobile station capable of accessing a multicast wireless communication network comprising a plurality of base stations is provided. The mobile station is configured to receive from one of the base stations a plurality of data packets. The mobile station is also configured to receive from the one base station at least one redundancy packet. The redundancy packet is created by using at least two of the plurality of data packets and binary XOR addition. The mobile station is further configured to recover a data packet received in error from the one base station by using the at least one redundancy packet, a subset of the plurality of data packets and XOR binary addition.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary generation of subpackets in Hybrid ARQ;

FIG. 2 illustrates an example of N-channel stop-and-wait (SAW) synchronous Hybrid ARQ protocol in a wireless communication system;

FIG. 3 illustrates a Hybrid ARQ scheme for multicast transmission;

FIG. 4 illustrates multicast redundant packet transmission from a base station and decoding procedures at a plurality of mobile stations, according to one embodiment of the present disclosure;

FIG. 5 illustrates a multicast procedure where the coded redundancy packet is transmitted every N packets, according to another embodiment of the present disclosure;

FIG. 6 illustrates a multicast coding operation according to another embodiment of the present disclosure;

FIG. 7 illustrates a multicast coding operation according to yet another embodiment of the present disclosure;

FIG. 8 illustrates a multicast coding operation with unequal error protection for different packets according to another embodiment of the present disclosure;

FIG. 9 illustrates a hierarchical multicast coding scheme according to another embodiment of the present disclosure;

FIG. 10 illustrates a tree view of a hierarchical multicast coding scheme according to another embodiment of the present disclosure;

FIG. 11 illustrates redundancy multicast packet transmission in a multiple-input multiple-output (MIMO) system according to yet another embodiment of the present disclosure; and

FIG. 12 illustrates multicast network coding with multi-slot transmission according to a further embodiment of the present disclosure.

### DETAILED DESCRIPTION OF THE INVENTION

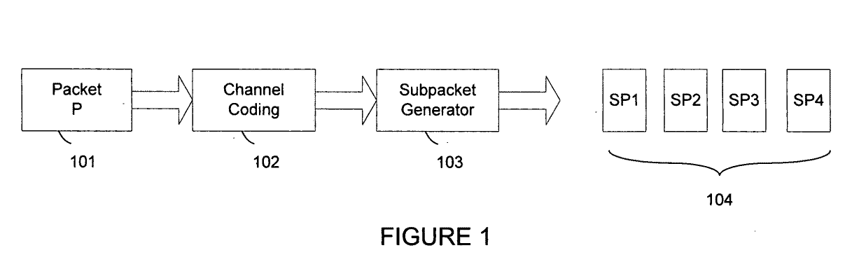

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless network.

FIG. 1 illustrates an exemplary generation of subpackets in Hybrid ARQ. Hybrid ARQ is a retransmission scheme whereby the transmitter sends redundant coded information. In one aspect of operation, the generation of subpackets starts with a standard information packet 101. Channel coding is performed at 102 on information packet 101 to create a coded bit stream. Next, subpacket generator 103 breaks the resulting coded bit stream into smaller subpackets 104.

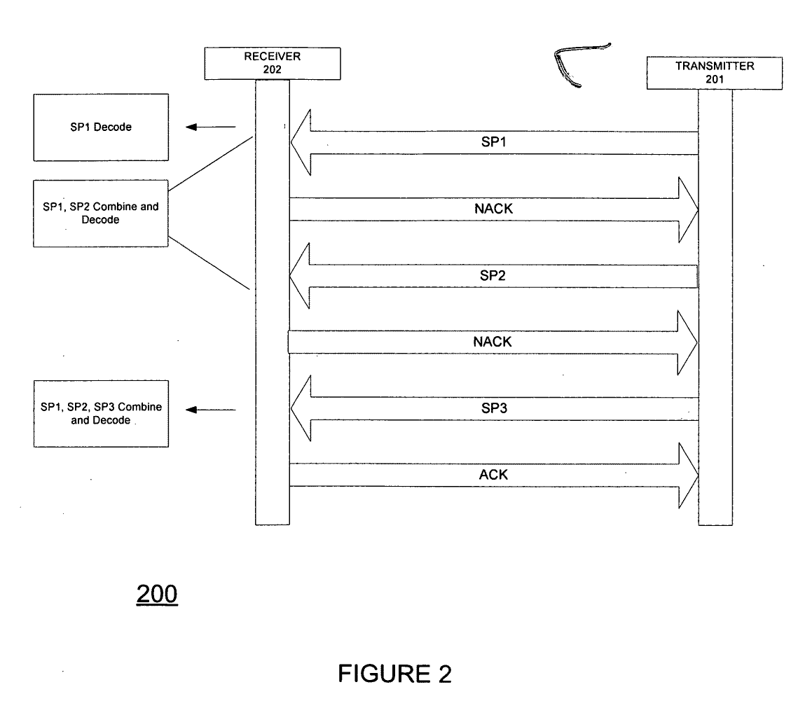

FIG. 2 illustrates an example of N-channel stop-and-wait (SAW) synchronous Hybrid ARQ protocol in a wireless communication system 200. In the example of FIG. 2, N equals 4. The wireless communication system 200 includes a transmitter 201 and a receiver 202. In one aspect of operation, transmitter 201 transmits a first subpacket SP1 to receiver 202. Receiver 202 tries to decode the information after receiving subpacket SP1. If receiver 202 is unsuccessful in decoding subpacket SP1, receiver 202 stores subpacket SP1 and sends a NACK (negative acknowledge) signal to transmitter 201. After receiving the NACK signal, transmitter 201 performs transmission of a second subpacket SP2. After receiving the second subpacket, receiver 202 combines SP2 with the previously stored subpacket SP1 and tries to jointly decode the information packet. At any point, if the information packet is successfully decoded by indication of a successful cyclic redundancy check (CRC), receiver 202 sends an ACK (acknowledge) signal to transmitter 201.

In the example shown in FIG. 2, the information packet is successfully decoded after receiving and combining three subpackets, SP1, SP2 and SP3. The HARQ protocol shown in FIG. 2 is generally referred to as stop-and-wait protocol because transmitter 201 waits for the ACK/NACK signal before sending the next subpacket. After receiving the ACK signal, transmitter 201 can move on to the transmission of a new information packet to the same or a different user. If the subpackets are the original coded packet, then the HARQ scheme specializes to chase combining. However, if subpackets are fractional segments of the original coded packet, they provide incremental redundancy to the receiver.

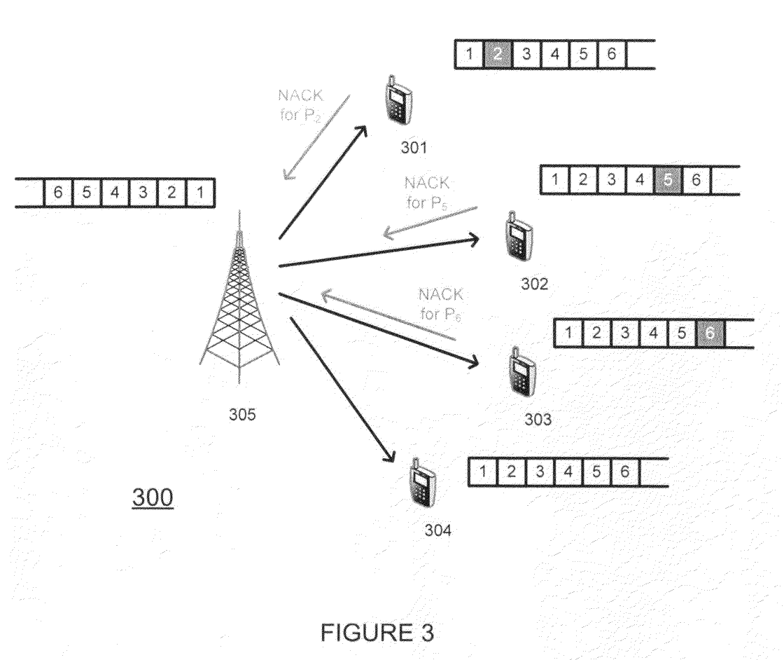

Traditionally in cellular systems, multicast transmissions have been open loop transmissions where all communication from base station to mobile stations is unidirectional. There is no feedback from the mobile stations to the base station. Open loop indicates that the mobile stations do not transmit an ACK or a NACK to the base station. Therefore the base station has to be conservative in its choice of modulation and coding (e.g., use lower coding rates and modulation orders) to ensure that enough mobile stations receive the packet with acceptably low error (e.g., 956 of mobile stations receive the packet with only 1% error). While having a conservative transmission scheme for multicast incorporating open loop only makes the design simpler, it also means that the base station cannot adapt to the channel conditions, which might make multicasting inefficient. Note that employing Hybrid ARQ to one user would mean that all users that have decoded the packet will have to receive it. Such a system would waste valuable network resources. To overcome this inefficiency, an efficient Hybrid ARQ for multicast transmissions has been proposed in R1-082815, “Discussion on Technologies for further enhanced MBMS”, Alcatel Shanghai Bell, Alcatel Lucent, 3GPP RAN1 contribution, Jeju Island, KR, August 2008 (hereafter “Alcatel reference”), the contents of which are incorporated herein by reference. [027] FIG. 3 illustrates a Hybrid ARQ scheme for multicast transmission. In a multicast system such as the one depicted in FIG. 3, a base station transmits a sequence of N packets and requests mobile stations to NACK after N packets are transmitted.

The wireless network 300 in FIG. 3 includes a base station 305 and a plurality of mobile stations 301-304 that are in communication with base station 305. In one aspect of operation, base station 305 multicasts six packets, P₁-P₆, to mobile stations 301-304. After receiving all six packets, each mobile station 301-304 transmits a NACK back to base station 305 for the packet that the mobile station could not decode. For example, mobile station 301 transmits a NACK for P₂, mobile station 302 transmits a NACK for P₅, and mobile station 303 transmits a NACK for P₆. Mobile station 304 successfully decoded all six packets, so it does not transmit a NACK to base station 305. All ACKs are implicit and no overt transmission is required.

On receiving the NACKs, the Alcatel reference proposes a novel coding algorithm to save re-transmission resources. For example, if base station 305 receives NACKs for packets P₂, P₅ and P₆ from mobile stations 301, 302 and 303 respectively, then at the next transmission, base station 305 combines packets P₂ and P₅ (P₂⊕P₅) using an XOR operation, and multicasts the result to all users. P₆ is retransmitted by itself in the next transmission instance. Mobile station 301, on receiving the first re-transmission, combines using an XOR operation the first retransmission packet with P₅, which it had correctly decoded earlier, to recover P₂. This is expressed by the equation P₂=(P₂⊕P₅)⊕P₅ where ⊕ denotes modulo 2 (XOR) addition. Similarly, mobile station 302 combines using an XOR operation the first re-transmission packet with P₂ to recover P₅, or P₅=(P₂⊕P₅)⊕P₂. Mobile station 303 ignores the first re-transmission packet and decodes only the second re-transmission packet which contains only P₆. This method of encoding retransmission packets could save a third of the resources needed compared to traditional packet retransmission techniques.

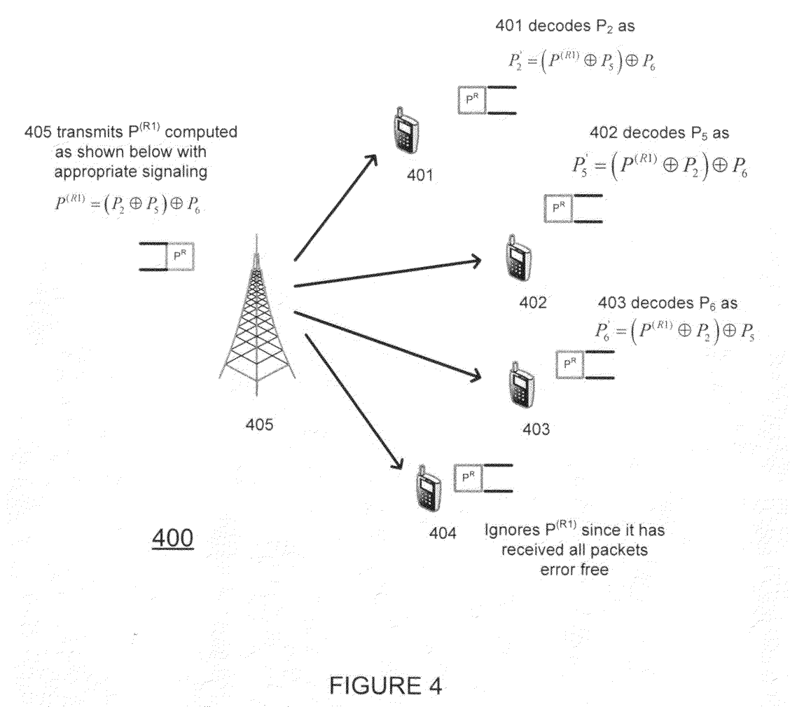

FIG. 4 illustrates multicast redundant packet transmission from a base station and decoding procedures at a plurality of mobile stations, according to one embodiment of the present disclosure. In this embodiment, the inherent nature of multicast transmission is leveraged to reduce the retransmission overhead. Multiple methods are disclosed for efficient multicast retransmission by coding in schemes where HARQ is used for multicast, and also for the traditional open-loop multicasting where HARQ methods are not used.

FIG. 4 depicts a wireless network 400 that includes a base station 405 and a plurality of mobile stations 401-404 that are in communication with base station 405. The embodiment of wireless network 400 is for illustration only. Other embodiments of wireless network 400 could be used without departing from the scope of this disclosure.

During communication, base station 405 collects the NACKs from all mobile stations 401-404 that receive the multicast data. The NACKs inform base station 405 of which packets were received in error at each of the mobile stations 401-404. Base station 405 then transmits a redundancy packet that is coded using the following procedure. As an example, suppose packets P₂, P₅ and P₆ are in error at mobile stations 401, 402 and 403 respectively. Except for the packets in error, all other packets have been received correctly at the respective mobile stations. Mobile station 404 received all packets without error. Base station 405 generates a redundancy packet p^{(R1)} using a binary XOR, or modulo 2 addition, of the packets. The modulo 2 addition can be described by the following equation:

p^{(R1)}=(P₂⊕P₅)⊕P₆,

where ⊕ denotes modulo 2 addition. Redundancy packet p^{(R1)} is multicast to all mobile stations 401-404 along with a signal indicating that the packet is a combination of packets P₂, P₅ and P₆ In contrast to conventional re-transmission methods, where only two packets are combined, the multicast nature of this embodiment is being used advantageously. By aggressively combining many packets, the re-transmission overhead has been reduced, thus making the overall transmission more efficient than the method proposed in the Alcatel reference.

On receiving redundancy packet p^{(R1)}, mobile stations 401-403 perform a series of modulo 2 additions to recover the packet in error. In the exemplary embodiment shown, mobile station 401 XORs the received bits in p^{(R1)} with packet P₅ whose output is XORed with packet P₆ to recover the erroneous packet P′₂. This operation at mobile station 401 can be mathematically expressed as follows:

P′₂=(P^{(R1)}⊕P₅)⊕P₆.

Similarly, mobile station 402 XORs the received bits in P^{(R1)} with packet P₂ whose output is XORed with packet P₆ to recover the erroneous packet P′₅. This operation at mobile station 402 can be mathematically expressed as follows:

P′₅=(P^{(R1)}⊕P₂)⊕P₆.

Similarly, mobile station 403 XORs the received bits in p^{(R1)} with packet P₂ whose output is XORed with packet P₅ to recover the erroneous packet P₆. This operation at mobile station 403 can be mathematically expressed as follows:

P′₆=(P^{(R1)}⊕P₂)⊕P₅.

Thus with a single redundancy packet that carries the combined information for the packets in error, the errors can be remedied. In contrast, conventional re-transmission methods require at least 2 redundancy packets.

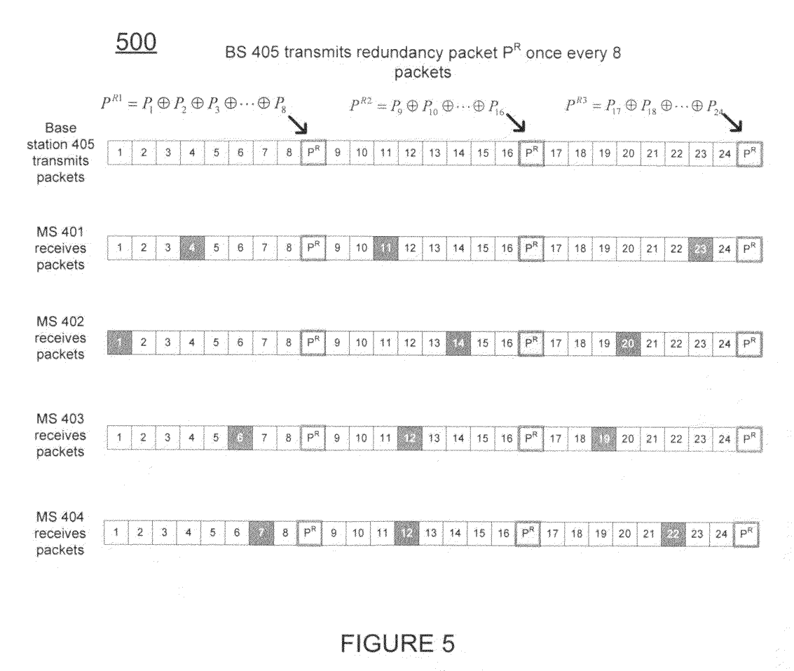

FIG. 5 illustrates a multicast procedure where the coded redundancy packet is transmitted every N packets, according to another embodiment of the present disclosure. Multicast procedure 500 is implemented in a wireless network, such as network 400 shown in FIG. 4. Multicast procedure 500 starts with base station 405 transmitting packets, with a redundancy packet transmitted every N packets. In the embodiment shown in FIG. 5, N equals 8. Each of the redundancy packets p^{R1}, p^{R2} and p^{R3} is generated at base station 405 by repeated modulo 2 additions of the previous N-1 packets. For example, to generate redundancy packet p^{R1}, the first two packets P₁ and P₂ are XORed, and the output is XORed again with P₃ whose output is XORed with P₄. The output of the previous XOR is XORed with the newer packet (N-2) times, or equivalently until the (N-1)^{th} packet is added to this redundancy packet. This operation can be described by the following pseudo-code:

P_{N}^{R}=[0 . . . 0].

For i=1:N-1

P_{N}^{R}=P₁⊕P_{N}^{R}

End.

Each of the redundancy packets p^{R1}, p^{R2} and p^{R3} is multicast as the Nth packet to mobile stations 401-404. This process is repeated every N packets. The frequency of the redundancy transmission may be configured semi-statically or kept fixed. The frequency must be signaled to mobile stations 401-404 only at configuration and only when the frequency changes. This procedure can recover up to one packet in error in each mobile station 401-404.

Upon receiving each redundancy packet, each mobile station 401-404 will perform XOR addition on the redundancy packet and each correctly decoded packet to recover the one packet in error. For example, in FIG. 5, mobile station 401 correctly decoded packets 1-3 and 5-8, but received packet 4 in error. Upon receiving redundancy packet p^{R1} from base station 405, mobile station will XOR redundancy packet p^{R1} with each of packets 1-3 and 5-8 to recover packet 4. Likewise, mobile station 402 can use redundancy packet p^{R1} and correctly coded packets 2-8 to recover error packet 1. Mobile stations 403 and 404 can use redundancy packet p^{R1} and their correctly coded packets to recover error packets 6 and 7 respectively.

In addition to reduced redundancy in retransmission, the advantage of this type of coding at the redundancy packet is that base station 405 need not know which packet is in error at each mobile station 401-404. As long as only one packet in every N packets is received in error at each mobile station 401-404, the redundancy packet can be used to recover the erroneous packet. This type of multicast coding does not require the Hybrid ARQ process to transmit the redundancy packet. Thus, it reduces signaling overhead from mobile stations 401-404 to base station 405 and saves resources in the physical layer.

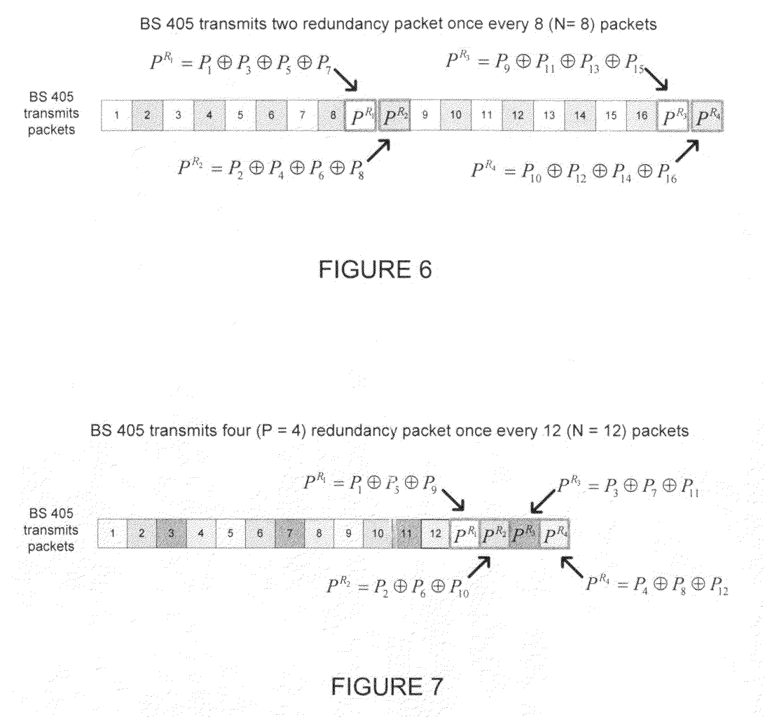

FIG. 6 illustrates a multicast coding operation according to another embodiment of the present disclosure. The multicast coding operation is performed in a wireless network, such as network 400 shown in FIG. 4. In this embodiment, base station 405 transmits two redundancy packets p^{R1} and p^{R2} after every N packets. In the example shown in FIG. 6, N equals 8. The first redundancy packet p^{R1} is generated by applying the XOR operation to a subset of packets. The second redundancy packet p^{R2} is generated by XORing all the remaining packets that were not combined to generate the first redundancy packet. The process is repeated with two more redundancy packets p^{R3} and p^{R4} created after the next N packets. Thus, with two redundancy packets, up to two erroneous packets can be corrected at each mobile station.

In the particular example shown in FIG. 6, redundancy packets p^{R1} and p^{R3} are generated by combining all of the odd-numbered packets using the XOR operation. Redundancy packets p^{R2} and p^{R4} are generated by using the XOR operation to combine all even-numbered packets. Other subsets of packets could be used for each redundancy packet. For example, redundancy packets p^{R1} and p^{R3} could be generated by combining the even-numbered packets, and redundancy packets p^{R2} and p^{R4} could be generated by combining the odd-numbered packets.

FIG. 7 illustrates a multicast coding operation according to yet another embodiment of the present disclosure. The multicast coding operation is performed in a wireless network, such as network 400 shown in FIG. 4. In this embodiment, base station 405 transmits P redundancy packets after every N packets according to the following rule: After N packets are transmitted, base station 405 combines every p^{th} packet starting from the first packet to generate the first redundancy packet p^{R1}, i.e., by XORing packets with numbers P*(i-1)+1 where i=1, . . . ,N. The second redundancy packet p^{R2}, is generated by using an XOR operation to combine packets with numbers P*(i-1)+2 where i=1, . . . ,N. This procedure is repeated for any p^{th} redundancy packet, P^{R}^{ₚ}, by using the XOR operation to combine on packets with numbers P*(i-1)+p where i=1, . . . ,N until all P redundancy packets are generated.

In the particular example illustrated in FIG. 7, P equals 4 and N equals 12. Redundancy packet p^{R1} is generated from packets P₁, P₅ and P₉. Redundancy packet p^{R2} is generated from packets P₂, P₆ and P₁₀. Redundancy packet p^{R3} is generated from packets P₃, P₇ and P₁₁. And redundancy packet p^{R4} is generated from packets P₄, P₈ and P₁₂. These redundancy packets can correct up to P erroneous packets in the N packets transmitted. Mobile stations 401-404, on receiving the redundancy packets, can use them to correct erroneous packets, if any. Or each mobile station can ignore the p^{th} redundancy packet if all packets with numbers with numbers P*(i-1)+p where i=1, . . . ,N have been correctly decoded.

This method generates redundancy packets using evenly-spaced, non-sequential data packets (e.g., P₁, P₅ and P₉). This has the advantage of broad redundancy, even if multiple sequential packets are received in error. Using the example illustrated in FIG. 7, suppose packets P₅-P₈ were all received in error. Each packet could still be corrected because each packet is part of a different redundancy packet.

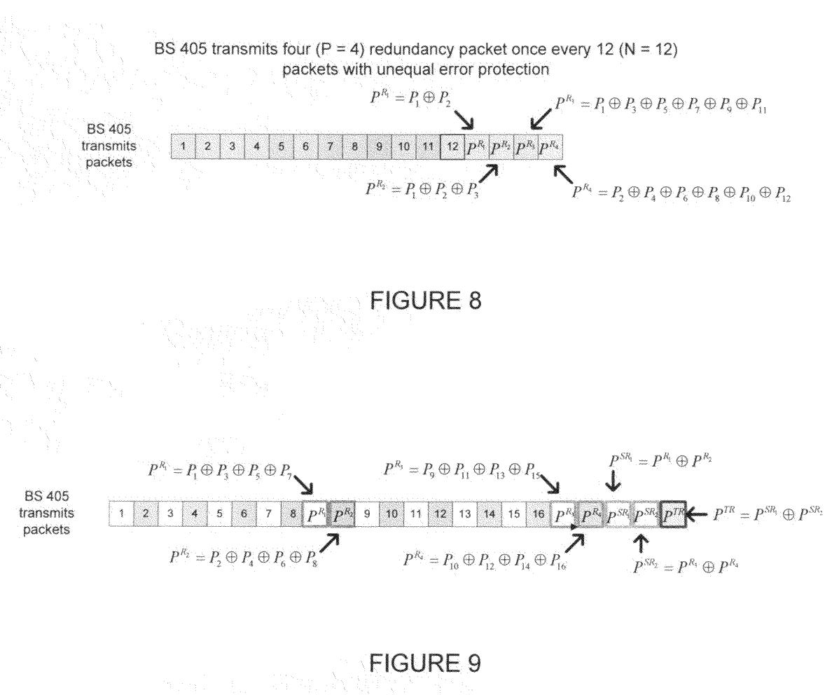

FIG. 8 illustrates a multicast coding operation with unequal error protection for different packets according to another embodiment of the present disclosure. In this embodiment, the rule to create the P redundancy packets at base station 405 is made configurable. This configurable redundancy packet generation gives base station 405 the flexibility to tailor the error protection to specific needs. For example, if the first three packets P₁, P₂ and P₃ need greater protection than the other packets, base station 405 can create redundancy packets p^{R1} and p^{R2} just to protect the first three packets and combine the rest of the packets in different combinations into P-2 redundancy packets. As a result, packet P₁ is represented in three redundancy packets p^{R1}, p^{R2} and p^{R3}. This allows for three additional opportunities for a mobile station to recover packet P₁ if it is received in error. The combinations of packets used in FIG. 8 are merely for illustrative purposes. Other combinations of packets could be used to provide the level of redundancy needed to ensure that important packets are transmitted correctly. Because the combinations are configurable at the base station level, the combinations must be signaled to all mobile stations in order for each mobile station to know what formula to use to decode any packets in error.

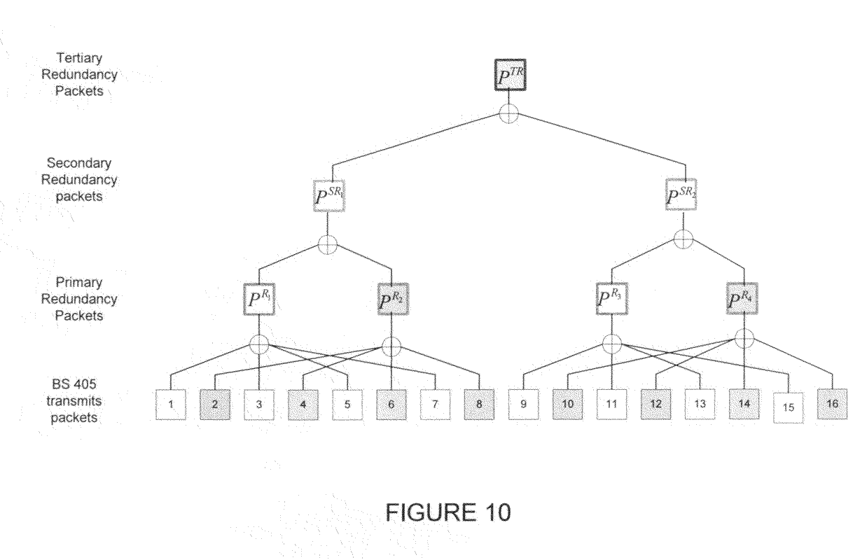

FIGS. 9 and 10 illustrate a hierarchical multicast coding scheme according to another embodiment of the present disclosure. In this embodiment, the redundancy packets are generated by combining data packets, as described above in earlier embodiments. Then the redundancy packets themselves are further combined using an XOR operation to generate secondary redundancy packets which offer protection to the redundancy packets. These secondary redundancy packets can be combined further into tertiary redundancy packets. Secondary and tertiary redundancy packets can be useful in situations where the first-level redundancy packet itself becomes corrupted. In the example shown in FIG. 9, base station 405 generates two redundancy packets after every 8 packets, p^{R1}, p^{R2}, p^{R3} and p^{R4}. Base station 405 then combines two redundancy packets p^{R1} and p^{R2} using XOR addition to generate one secondary redundancy packet p^{SR1}. Base station 405 also combines redundancy packets p^{R3} and p^{R4} to generate a second secondary redundancy packet p^{SR2}. The two secondary redundancy packets p^{SR1} and p^{SR2} are further combined using XOR addition into tertiary redundancy packet p^{TR}. FIG. 10 shows a tree diagram of the hierarchical multicast coding example shown in FIG. 9. It will be understood that multiple tertiary redundancy packets can be combined into fourth-level redundancy packets, multiple fourth-level redundancy packets can be combined into fifth-level redundancy packets, and so on. As a general rule, an N^{th} level redundancy packet can be generated by combining two or more N-1^{th} level redundancy packets. The frequency of transmitting such secondary, tertiary, and N^{th} level redundancy packets, and the subsets of first-level redundancy packets that they comprise, can be pre-configured in the network.

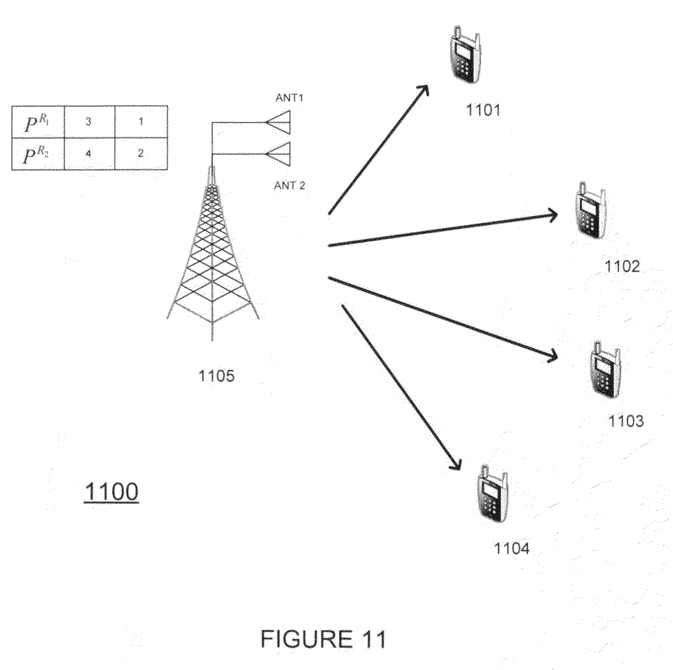

FIG. 11 illustrates redundancy multicast packet transmission in a multiple-input multiple-output (MIMO) system according to yet another embodiment of the present disclosure. In one aspect of operation, MIMO base station 1105 transmits two packets as two spatial streams using at least two antennas. This scheme is called multi-codeword MIMO transmission. The packets from MIMO base station 1105 can be combined and transmitted as a single redundancy packet. Base station 1105 can transmit two redundancy packets at one time using multiple antennas for every four code words transmitted. In this embodiment, system 1100 leverages multiple antennas to transmit multiple redundancy packets at one time to users. For example, in system 1100, the redundancy packets could be p^{R1}=P₁⊕P₂ and p^{R1}=P₃⊕P₄. The frequency and messages combined in the redundancy packets are configurable to the particular need. All embodiments of the current disclosure described above on multicast redundancy retransmissions are applicable here.

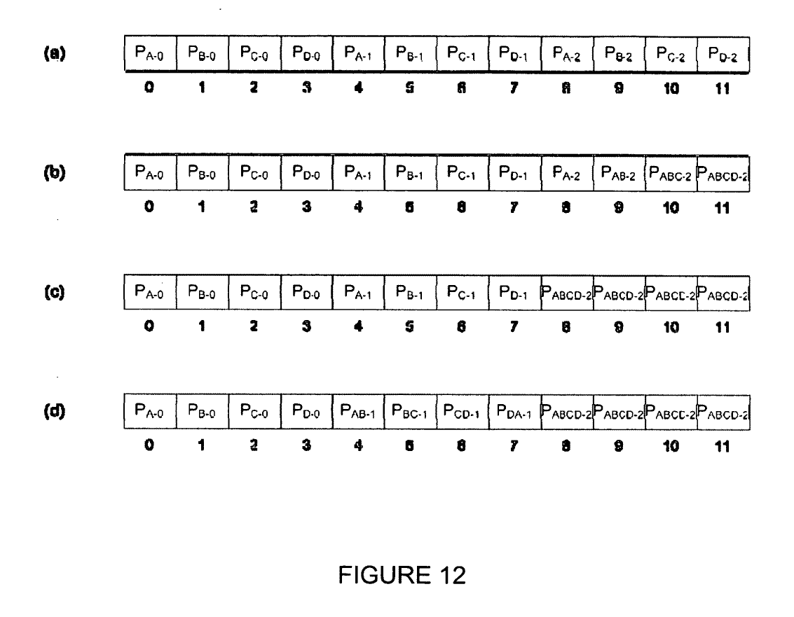

FIG. 12 illustrates multicast network coding with multi-slot transmission according to further embodiments of the present disclosure. In one aspect of operation, a first version of a first packet and a first version of a second packet are generated and transmitted separately while a network-encoded version of both packets is generated by using XOR operation on a second version of the first packet and a second version of the second packet.

As an example, assume the receiver correctly decodes the first packet after receiving the first version of the first packet but cannot correctly decode the second packet after receiving the first version of the second packet. Upon receiving the network-encoded version of both packets, the receiver can remove the information of the first packet from the network-encoded version of both packets by using XOR operation on the second version of the first packet and the network-encoded version of both packets. The receiver can then attempt to decode the second packet by using the output of the XOR operation. The receiver may also combine the output of the XOR operation together with the received first version of the second packet to decode the second packet. Similarly, if the receiver correctly decodes the second packet after receiving the first version of the second packet but cannot correctly decodes the first packet after receiving the first version of the first packet, similar procedure applies in order to decode the first packet upon receiving the network-encoded version of both packets.

For example, FIG. 12(a) shows multi-slot transmission of packets A, B, C, and D. Packet A is transmitted using three versions (or equivalently, three slots, or three transmissions) P_{A-0}, P_{A-1}, and P_{A-2}. Likewise, packet B is transmitted using P_{B-0}, P_{B-1} and P_{B-2}; packet C is transmitted using P_{C-0}, P_{C-1}, P_{C-2}; and packet D is transmitted using P_{D-0}, P_{D-1} and P_{D-2}.

FIG. 12(b) shows one example of applying network coding to some of the transmissions of Packet B, C, and D. In slot 9, instead of transmitting P_{B-2}, the transmitter can transmit P_{AB-2}=P_{A-2}⊕P_{B-2}. In slot 10, instead of transmitting P_{C-2}, the transmitter can transmit P_{ABC-2}=P_{A-2}⊕P_{B-2}⊕P_{C-2}. In slot 11, instead of transmitting P_{D-2}, the transmitter can transmit P_{ABCD-2}=P_{A-2}⊕P_{B-2}⊕P_{C-2}⊕P_{D-2}.

FIG. 12(c) shows another example of applying network coding to some of the transmissions of Packet A, B, C, and D. In slot 8, 9, 10, and 11, P_{ABCD-2} is repeated four times.

FIG. 12(d) shows another example of applying network coding to some of the transmissions of Packet A, B, C, and D. In slot 4, P_{AB-1}=P_{A-1}⊕P_{B-1} is transmitted. In slot 5, P_{BC-1}=P_{B-1}⊕P_{C-1} is transmitted. In slot 6, P_{CD-1}=P_{C-1}⊕P_{D-1} is transmitted. In slot 7, P_{DA-1}=P_{D-1}⊕P_{A-1} is transmitted. In slot 8, 9, 10, and 11, P_{ABCD-2} is repeated four times.

All these different examples of applying XOR operation to some of the transmissions of two or multiple packets have different advantages and disadvantages. But in general, they all enable more robust transmission of these packets with slight increase of computational complexity. It is noted that the order, composition and frequency of the redundancy packets can be changed to suit the particular circumstances.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use in a multicast wireless communication network comprising a plurality of base stations, a method for encoding retransmissions to a plurality of mobile stations, the method comprising the steps of:
transmitting a plurality of data packets to the plurality of mobile stations;
creating at least one redundancy packet by using at least two of the plurality of data packets and binary XOR addition; and
transmitting the at least one redundancy packet to the plurality of mobile stations.

2. The method as set forth in claim 1, the method further comprising the step of:
receiving a plurality of NACK signals from the plurality of mobile stations, each NACK signal indicating a data packet received in error at one of the mobile stations,
wherein creating the at least one redundancy packet comprises adding the plurality of data packets received in error using binary XOR addition.

3. The method as set forth in claim 1, wherein transmitting the at least one redundancy packet to the plurality of mobile stations comprises transmitting one redundancy packet after every N data packets,
wherein each redundancy packet is created by adding the N data packets using binary XOR addition.

4. The method as set forth in claim 1, wherein transmitting the at least one redundancy packet to the plurality of mobile stations comprises transmitting a first and second redundancy packet after every N data packets,
wherein the first redundancy packet is created by adding every odd-numbered data packet of the N data packets using a binary XOR addition, and
wherein the second redundancy packet is created by adding every even-numbered data packet of the N data packets using binary XOR addition.

5. The method as set forth in claim 1, wherein transmitting the at least one redundancy packet to the plurality of mobile stations comprises transmitting P redundancy packets after every N data packets,
wherein each of the P redundancy packets is created by adding a subset of the N data packets using binary XOR addition.

6. The method as set forth in claim 1, wherein the at least one redundancy packet is created according to a rule, the rule indicating a subset of the plurality of data packets to be added together using binary XOR addition,
wherein the rule is configurable at each base station, and
wherein the rule is transmitted to the plurality of mobile stations.

7. The method as set forth in claim 1, the method further comprising the steps of:
transmitting at least one secondary redundancy packet to the plurality of mobile stations, wherein each secondary redundancy packet is created by adding at least two of the redundancy packets using binary XOR addition.

8. The method as set forth in claim 1, the method further comprising the steps of:
transmitting at least one N^{th} level redundancy packet to the plurality of mobile stations, wherein each N^{th} level redundancy packet is created by adding at least two N-1^{th} level redundancy packets using binary XOR addition.

9. The method as set forth in claim 1, wherein a first subset of the plurality of data packets is transmitted from a first antenna of a base station, and a second subset of the plurality of data packets is transmitted from a second antenna of the base station, and wherein each of the at least one redundancy packet is created by adding the first and second subsets of data packets using binary XOR addition.

10. A multicast wireless communication network comprising a plurality of base stations, each of the base stations capable of encoding retransmissions to a plurality of mobile stations, each base station configured to:
transmit a plurality of data packets to the plurality of mobile stations;
create at least one redundancy packet by using at least two of the plurality of data packets and binary XOR addition; and
transmit the at least one redundancy packet to the plurality of mobile stations.

11. The multicast wireless communication network as set forth in claim 10, each base station further configured to:
receive a plurality of NACK signals from the plurality of mobile stations, each NACK signal indicating a data packet received in error at one of the mobile stations; and
create the at least one redundancy packet by adding the plurality of data packets received in error using binary XOR addition.

12. The multicast wireless communication network as set forth in claim 10, each base station further configured to transmit one redundancy packet after every N data packets,
wherein each redundancy packet is created by adding the N data packets using binary XOR addition.

13. The multicast wireless communication network as set forth in claim 10, each base station further configured to transmit a first and second redundancy packet after every N data packets,
wherein the first redundancy packet is created by adding every odd-numbered data packet of the N data packets using binary XOR addition, and
wherein the second redundancy packet is created by adding every even-numbered data packet of the N data packets using binary XOR addition.

14. The multicast wireless communication network as set forth in claim 10, each base station further configured to transmit P redundancy packets after every N data packets,
wherein each of the P redundancy packets is created by adding a subset of the N data packets using binary XOR addition.

15. The multicast wireless communication network as set forth in claim 10, each base station further configured to:
create the at least one redundancy packet according to a rule, the rule indicating a subset of the plurality of data packets to be added together using binary XOR addition; and
transmit the rule for creating the at least one redundancy packet to the plurality of mobile stations,
wherein the rule is configurable at each base station.

16. The multicast wireless communication network as set forth in claim 10, each base station further configured to:
transmit at least one secondary redundancy packet to the plurality of mobile stations, wherein the at least one secondary redundancy packet is created by adding a subset of the at least one redundancy packet using binary XOR addition.

17. The multicast wireless communication network as set forth in claim 10, wherein a first subset of the plurality of data packets is transmitted from a first antenna of a base station, and a second subset of the plurality of data packets is transmitted from a second antenna of the base station, and wherein each of the at least one redundancy packet is created by adding the first and second subsets of data packets using binary XOR addition.

18. A mobile station capable of accessing a multicast wireless communication network comprising a plurality of base stations, the mobile station configured to:
receive from one of the base stations a plurality of data packets;
receive from the one base station at least one redundancy packet, the at least one redundancy packet created by using at least two of the plurality of data packets and binary XOR addition; and
recover a data packet received in error from the one base station by using the at least one redundancy packet, a subset of the plurality of data packets and XOR binary addition.

19. The mobile station as set forth in claim 18, the mobile station further configured to:
receive from the one base station one redundancy packet after every N data packets, wherein one of the N data packets is received in error; and
recover the one data packet received in error by adding the one redundancy packet and each of the N data packets other than the one data packet received in error using XOR binary addition.

20. The mobile station as set forth in claim 18, wherein the at least one redundancy packet is created according to a rule, the rule indicating a subset of the plurality of data packets to be added together using binary XOR addition, the mobile station further configured to:
receive the rule from the one base station,
use the rule to recover the data packet received in error from the one base station.

21. The mobile station as set forth in claim 18, the mobile station further configured to:
transmit a plurality of NACK signals to the one base station, each NACK signal indicating a data packet received in error.
